(19) United States
(12) Patent Application Publication
(10) Pub. No.: US 2023/0394478 A1
(43) Pub. Date: Dec. 7, 2023

(54) GENERATING AND PUBLISHING UNIFIED TRANSACTION STREAMS FROM A PLURALITY OF COMPUTER NETWORKS FOR DOWNSTREAM COMPUTER SERVICE SYSTEMS

(71) Applicant: Chime Financial, Inc., San Francisco, CA (US)

(72) Inventors: Jacques Fuentes, Richmond, VA (US); Rajesh Mancheri, Union City, CA (US); Praveen Jain, San Mateo, CA (US); David Lyons, Oakland, CA (US); Fletcher Fowler, Portsmouth, NH (US); Michael Soares, Los Angeles, CA (US)

(21) Appl. No.: 17/805,385

(22) Filed: Jun. 3, 2022

(51) Int. Cl. G06Q 20/38; G06Q 20/40

(52) U.S. Cl. CPC G06Q 20/389; G06Q 20/401; G06Q 20/3821

(57) ABSTRACT

The disclosure describes embodiments of systems, methods, and non-transitory computer readable storage media that generates and publishes unified transaction streams from a plurality of computer networks for downstream computer service systems. In particular, in one or more embodiments, the disclosed systems identify transaction information over time from a variety of different transaction computer networks. For example, the disclosed systems identify different transaction events at different times from different transaction computer networks that utilize individual transaction schemas. The disclosed systems dynamic ally convert and combine these transaction events in real time to generate and publish a unified transaction stream for utilization by a variety of computer service systems.

### BACKGROUND

Recent years have seen significant developments in systems that utilize distributed computing resources to process large data volumes in generating and managing digital accounts across computer networks. For example, conventional systems utilize a variety of computing devices to manage and track ledgers for various users to provide digital accounts and corresponding updates to client computing devices. To illustrate, conventional systems track data volumes regarding utilization of assets across a variety of computer networks and dynamically update and manage digital accounts for client devices to manage these assets. Although conventional systems utilize various computer-implemented algorithms to generate and manage digital accounts, conventional systems suffer from a number of technical deficiencies, particularly with regard to efficiency, security, and flexibility of implementing computing devices.

For example, in tracking assets for digital accounts across computer networks conventional systems are often computationally inefficient. To illustrate, in processing transactions of assets, there are often a variety of different stages and events that occur in updating digital accounts to reflect asset modifications. These stages/events are often executed at different times through various digital transmissions. These digital transmissions come from a variety of different computer networks, over a variety of different times, in a variety of individual data schemas. Accordingly, as downstream computer services need to access information regarding asset modifications, these systems utilize excessive computer resources (e.g., processing power and memory) in repeatedly querying, locating, accessing, and transferring the pertinent information for different stages/events of various asset transactions. Indeed, conventional systems often require monitoring and analysis of five or more transmission sources to reason about the state of a particular asset transaction.

These inefficiencies not only lead to increased computer resource utilization but undermine the flexibility and functionality of implementing computing devices. Indeed, repeatedly querying, locating, accessing, and transferring disparate data files regarding asset movement for digital accounts lead to increased latency. For example, conventional systems often take significant time to provide updated digital account information to client devices because of these inefficiencies. Similarly, these problems undermine scalability. For example, conventional systems are limited in the throughput and scale of digital information they can manage as a result of these inefficient processes.

In addition, conventional systems also lead to increased errors and inaccuracies. For example, because different stages/events for a transaction are processed from different networks, at different times, utilizing different schemas, conventional systems will often lose, omit, drop, or mishandle pertinent information for managing digital accounts. Indeed, conventional systems cannot accurately analyze reasons for state changes or other modifications with incomplete transaction information. Not only does this have the potential to undermine the accuracy of account information, but it also leads to additional inefficiencies in computing resources utilized to reconcile and prevent digital account discrepancies. Indeed, even if conventional systems are ultimately able to identify missing or inaccurate stages/events within a transaction, these systems expend significant time and resources to identify and address these inaccuracies.

Moreover, conventional systems also suffer from increased network security risks. Indeed, the approach discussed above makes it more difficult to identify malicious computing devices submitting fraudulent transactions or events to access assets reflected in digital accounts. For example, conventional systems that utilize machine learning models to search for, compile, and utilize digital information corresponding to asset transactions makes it more difficult for these systems to identify fraudulent devices intent on accessing or manipulating assets within secure digital accounts.

### SUMMARY

One or more embodiments provide and/or solve one or more problems in the art with systems, methods, and non-transitory computer readable storage media that generate and publish unified transaction streams for a plurality of computer networks for downstream computer service systems. In particular, in one or more embodiments the disclosed systems identify different transactions with different events from different transaction computer networks (that utilize different network schemas). In one or more implementations, the disclosed systems utilize a unified transaction model to dynamically convert these transactions and corresponding events to a unified transaction schema (e.g., a unified top level summary of the transaction and corresponding events). Moreover, the disclosed systems publish a unified transaction stream that includes the transactions (and corresponding events) in the unified transaction schema to a plurality of computer service systems, such as security analysis systems, data warehousing systems, or digital asset modification systems. In this manner, the disclosed systems can dynamically generate a unified transaction stream to more efficiently, accurately, flexibly, and securely manage data volumes and corresponding digital accounts.

Additional features and advantages of one or more embodiments of the present disclosure will be set forth in the description which follows, and in part will be obvious from the description, or may be learned by the practice of such example embodiments.

### BRIEF DESCRIPTION OF THE DRAWINGS

The detailed description is described with reference to the accompanying drawings in which:

FIG. 1 illustrates a schematic diagram of an environment for implementing an inter-network facilitation system and a unified transaction system in accordance with one or more implementations.

FIG. 2 illustrates generating a unified transaction stream having a unified transaction schema from transaction data corresponding to a plurality of transaction computer networks in accordance with one or more implementations.

FIG. 3 illustrates generating a unified transaction container in accordance with one or more implementations.

FIG. 4 illustrates generating and modifying a unified transaction container in accordance with one or more implementations.

FIG. 5 illustrates publishing and updating a unified transaction stream for a variety of computer service systems contact in accordance with one or more implementations.

FIG. 6 illustrates a schematic diagram of a computer platform for implementing a unified transaction system in accordance with one or more implementations.

FIG. 7 illustrates a flowchart of a series of acts for generating a unified transaction stream in accordance with one or more implementations.

FIG. 8 illustrates a block diagram of an exemplary computing device in accordance with one or more implementations.

FIG. 9 illustrates an example environment for an inter-network facilitation system in accordance with one or more implementations.

### DETAILED DESCRIPTION

The present disclosure describes one or more embodiments of a unified transaction system that generates and publishes unified transaction streams from a plurality of computer networks for downstream computer service systems. In particular, in one or more embodiments, the unified transaction system identifies transaction information over time from a variety of different transaction computer networks. For example, the unified transaction system identifies different transaction events at different times from different transaction computer networks that utilize individual transaction schemas. The unified transaction system dynamically converts and combines these transaction events in real time to generate and publish a unified transaction stream. For example, the unified transaction system identifies different events from different transaction computer networks, converts these events to a unified transaction schema, and then publishes an updating, real-time unified transaction stream to various computer service systems.

As just mentioned, in one or more embodiments the unified transaction system interacts with various transaction computer networks having various network schemas to identify digital transaction transmissions. For example, in one or more embodiments, the unified transaction system interacts with card transaction computer networks, ACH transaction computer networks, and/or transfer transaction computer networks. Moreover, each of these transaction computer networks can include a unique network schema with different fields, variables, naming conventions, and digital information. In addition, each of these transaction computer networks can provide digital information regarding different transactions and events. For instance, a card transaction computer network can transmit information regarding multiple events (authorization, a first settlement, a second settlement, etc.) over time corresponding to a single transaction.

In one or more embodiments, the unified transaction system converts transaction information from multiple transaction computer networks to a unified transaction schema. In particular, the unified transaction system utilizes a unified transaction model that maps individual network schemas to a unified transaction schema. To illustrate, the unified transaction system generates a unified transaction container that includes various unified identifiers for a transaction and updates the unified transaction container over time. For example, the unified transaction system generates a unified transaction container that includes a unified transaction identifier, a transaction version identifier, a transaction state, and event identifiers. Moreover, the unified transaction system modifies the transaction version identifier, the transaction state, and the event identifiers upon identifying additional transaction information from one or more transaction computer networks.

Moreover, as mentioned above, the unified transaction system also publishes a unified transaction stream to a variety of computer service systems. For example, in one or more embodiments, the unified transaction system publishes a unified transaction stream that continuously updates to reflect new transaction information. Computer service systems can subscribe to the unified transaction stream, which provides a single unified (versioned, and up-to-date) source for information regarding any particular transaction. Thus, for example, the unified transaction system can provide the unified transaction stream to a security analysis system (e.g., that generates risk and/or fraud predictions), a digital data warehousing system (e.g., for accurate data storage/management of transaction information), a transaction system (e.g., for implementing, processing, or generating additional transactions), or a digital asset modification system (e.g., for modifying assets within one or more digital accounts or ledgers).

As mentioned, in one or more embodiments the unified transaction system provides a variety of technical advantages relative to conventional systems. For example, in one or more embodiments the unified transaction system improves efficiency relative to conventional systems. For example, by generating a unified transaction stream in a unified transaction schema, the unified transaction system provides an efficient source for a variety of different computer service systems to access and utilize up-to-date (e.g., real time), consistent information regarding a variety of different transactions corresponding to a variety of different transaction computer networks. To illustrate, the unified transaction system can allow computer service systems to subscribe to the unified transaction stream, providing automated triggers and notifications regarding transactions and transaction events across computer service systems. By providing a single unified source for different transactions and transaction computer networks available across computer service systems, the unified transaction system significantly reduces computer resources utilized to repeatedly query, search for, identify, and provide transaction information.

Similarly, the unified transaction system also improves flexibility and functionality of implementing computing devices. For example, the unified transaction system can reduce latency and improve processing time in managing and updating digital accounts. To illustrate, the unified transaction system can provide a unified transaction stream that includes real-time transaction information, efficiently digestible via a variety of systems (such as a digital asset modification system) through a unified transaction schema. Accordingly, the digital asset modification system provides a one read path for real-time, consistent notifications of changes to digital assets. This allows systems, such as digital asset modification systems, to quickly and efficiently modify digital accounts and corresponding information available to client devices. Furthermore, the unified transaction system improves scalability. For example, by providing a unified transaction stream the unified transaction system improves throughput of information to various computer service systems.

Furthermore, the unified transaction system improves accuracy relative to conventional systems. Indeed, by dynamically converting transaction information to a unified transaction schema and providing a unified transaction stream, the unified transaction system reduces errors, lost transaction events, and inaccuracies in managing ledgers and corresponding digital accounts. In addition, the unified transaction stream allows the unified transaction system to more accurately reason regarding why state changes occur. Moreover, this improved accuracy also results in additional efficiency improvements in performing reconciliation processes.

Moreover, the unified transaction system also improves security. For example, by providing a single unified source for transaction information across transaction computer networks in a unified transaction schema, the unified transaction system can identify and prevent malicious computing devices from submitting fraudulent transactions or events to access assets reflected in digital accounts. To illustrate, the unified transaction system provides a unified transaction stream to one or more machine learning models for generating fraud or risk predictions. Because the unified transaction stream provides up-to-date, consistent, and accurate information across transaction computer networks via a unified transaction schema, these machine learning models are better able to identify malicious devices intent on manipulating assets within secure digital accounts.

As illustrated by the foregoing discussion, the present disclosure utilizes a variety of terms to describe features and advantages of the unified transaction system. Additional detail is now provided regarding the meaning of such terms. For example, as used herein, the term “transaction computer network” refers to a collection of one or more computing devices for implementing, initiating, or processing a transaction. To illustrate, a transaction computer network can include a card transaction computer network (e.g., for implementing card transactions, such as debit card or credit-card transactions), an ACH transaction computer network (e.g., for implementing ACH transactions, such as direct deposit), or a transfer computer network (e.g., for implementing transfers between accounts or peer-to-peer transactions). In some embodiments, a transaction computer network also includes a lending transaction computer network, an investing transaction computer network, a check deposit transaction computer network, or an insurance transaction computer network. The transaction computer network can also include a collection of computing devices within the inter-network facilitation system 104 (e.g., one or more of the server device(s) 102 that initiate transactions). For example, a transaction computer network can also initiate operational or internal adjustments, such as write offs, charge offs, escheatment, wage garnishment, or system corrections.

As used herein, the term transaction refers to an exchange of assets for other assets, goods, or services. In particular, a transaction can include a card transaction (e.g., a purchase of goods or services using a credit or debit card), an ACH transaction (e.g., an automated clearing house transaction or direct exchange of assets from one account to another, such as a direct deposit or electronic bill pay), or a transfer transaction (e.g., a transfer of assets between two or more accounts). A transaction can include a variety of transaction details, information, or events. For example, a transaction can include a variety of events, such as an authorization event, a first settlement event, or a second settlement event.

As mentioned above, various transaction computer networks can utilize various network schemas. As used herein, the term “network schema” refers to standards, formats, fields, descriptors, or data types corresponding to one or more computers (e.g., corresponding to transaction computer network). For example, a network schema can include a plurality of standardized fields, formats, or data structures for describing features of a transaction/event for a particular transaction computer network. Thus, for example, a card transaction computer network can utilize a card network schema (having a first set of fields and formats), an ACH transaction computer network can utilize an ACH network schema (having a second set of fields and formats), and a transfer computer network can utilize a transfer network schema (having a third set of fields and formats). In contrast, a “unified transaction schema” refers to a common set of standards, formats, fields, descriptors, or data types for a plurality of transactions (e.g., transactions from a variety of different transaction computer networks).

As mentioned, in one or more embodiments the unified transaction system utilizes a unified transaction model to convert a network schema to a unified transaction schema. As used herein, the term “unified transaction model” refers to a computer-implemented model for mapping, converting, translating, or transferring digital information corresponding to a transaction from a network schema to another schema (e.g., to a unified transaction schema). For example, the unified transaction model can include a heuristic model or machine learning model that analyzes a transaction with transaction details from a network schema of one or more transaction computer networks and converts the transaction details from the network schema to a unified transaction schema.

In one or more embodiments, the unified transaction system utilizes a unified transaction container as part of the unified transaction schema. As used herein, the term “unified transaction container” refers to a plurality of standardized fields for a digital transaction. In particular, a unified transaction container can include an array, database, matrix, or other data structure that includes standardized/labeled fields that can be populated with information corresponding to a transaction. For example, a unified transaction container can include a unified transaction identifier (e.g., a transaction ID), a transaction version identifier (e.g., a version sequence ID or number), a transaction state (e.g., an indicator of a current state of the transaction), and/or an event identifier (e.g., an event ID, symbol, field, or character denoting a particular event).

As used herein, the term “unified transaction stream” refers to a collection of one or more transactions in a unified transaction schema. In particular, a unified transaction stream includes a collection of transactions in a unified transaction schema (e.g., a collection of unified transaction containers) available to one or more computer service systems. For example, a unified transaction stream includes an updating collection of transactions in a unified transaction schema that computer service systems can receive (e.g., subscribe to or otherwise monitor to obtain alerts, notifications, or indications of pertinent transaction information).

As used herein, the term “computer service system” refers to one or more computer devices that utilizes, ingests, analyzes, or processes transaction information to perform one or more functions. For example, a computer service system can include a security analysis system, a digital data warehousing system, a transaction system, or a digital asset modification system.

As used herein, the term “account” refers to a repository of assets or sensitive information corresponding to a user. In particular, an account includes a financial account into and out of which cash or digital assets can be transferred. For example, an account may refer to a bank account, debit card account, cash card, credit card account, online accounts, or gift card account.

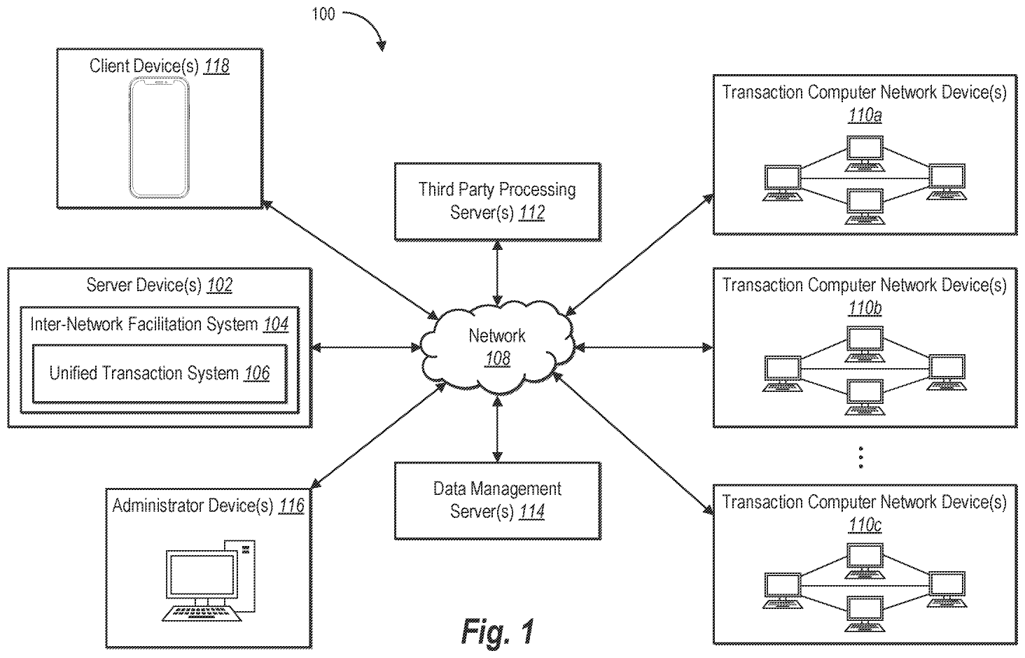

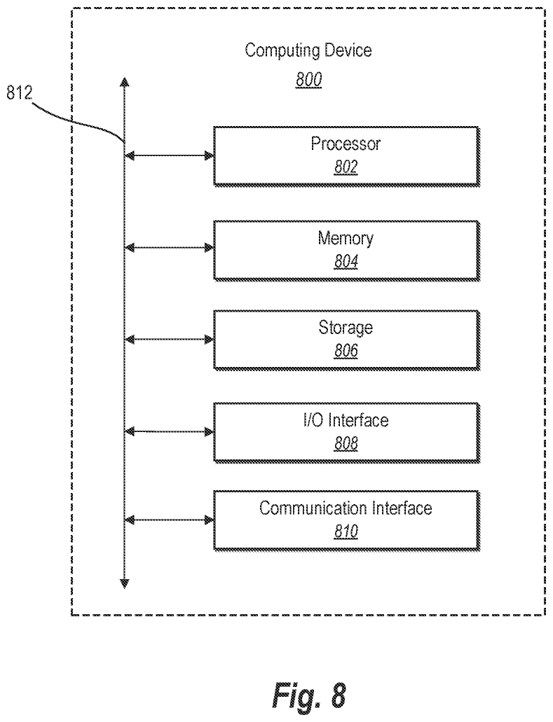

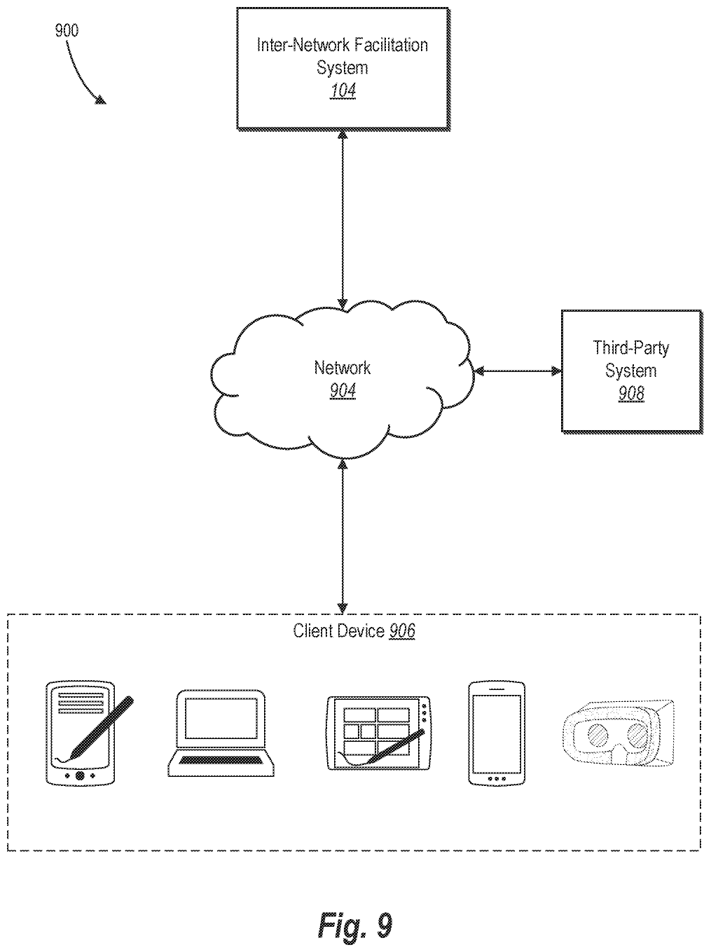

The following disclosure provides additional detail regarding the unified transaction system in relation to illustrative figures portraying example embodiments and implementations of the unified transaction system. For example, FIG. 1 illustrates a block diagram of a system environment (or “environment”) 100 for implementing an inter-network facilitation system 104 and a unified transaction system 106 in accordance with one or more embodiments. As shown in FIG. 1, the environment 100 includes server device(s) 102, various transaction computer network devices 108a-108c, third party processing server(s) 112, data management server(s) 114, administrator device(s) 116, and client device(s) 118 connected via a network 108. While FIG. 1 shows an embodiment of the unified transaction system 106, alternative embodiments and configurations are possible. Furthermore, although FIG. 1 illustrates the unified transaction system 106 being implemented by a particular component and/or device within the environment 100, the unified transaction system 106 can be implemented, in whole or in part, by other computing devices and/or components in the environment 100 (e.g., the administrator device(s) 116 and/or the client device(s) 118). Additional description regarding the illustrated computing devices is provided with respect to FIGS. 8-9 below.

As shown in FIG. 1, the server device(s) 102 can include the inter-network facilitation system 104. In some embodiments, the inter-network facilitation system 104 determines, stores, generates, and/or displays financial information corresponding to a user account (e.g., a banking application, a money transfer application). Furthermore, the inter-network facilitation system 104 can electronically communicate (or facilitate) financial transactions between one or more user accounts (and/or computing devices). In some embodiments, the inter-network facilitation system 104 also tracks and/or monitors financial transactions and/or financial transaction behaviors of a user within a user account.

Indeed, in some examples, the inter-network facilitation system 104 facilitates financial transactions and digital communications across different computing systems over one or more transaction computer networks. Indeed, as shown, the environment 100 also includes transaction computer network devices 110a-110c (or “transaction computer networks”). The transaction computer network devices 110a-110c can include a variety of computer devices for implementing, facilitating, processing, or executing a transaction. Thus, for instance, the transaction computer network devices 110a can include a card transaction computer network for implementing a variety of transactions using cards (e.g., credit cards, debit cards, etc.). Similarly, the transaction computer network devices 110b can include an ACH transaction computer network (e.g., computing devices for implementing ACH transactions), and the transaction computer network devices 110c can include a transfer transaction computer network (e.g., computing devices for implementing transfer transactions between accounts).

For example, the inter-network facilitation system 104 manages credit accounts, secured accounts, and other accounts for a single account registered within the inter-network facilitation system 104. In some cases, the inter-network facilitation system 104 is a centralized network system that facilitates access to online banking accounts, credit accounts, and other accounts within a central network location. Indeed, the inter-network facilitation system 104 can link accounts from different network-based financial institutions (e.g., the transaction computer network devices 110a-110c) to provide information regarding, and management tools for, the different accounts. Furthermore, the unified transaction system 106 can provide various user interfaces and information for display (e.g., via the administrator device(s) 116 and/or the client device(s) 118).

As also illustrated in FIG. 1, the environment 100 includes the administrator device(s) 116 and the client device(s) 118. For example, the administrator device(s) 116 and the client device(s) 118 may include, but are not limited to, a mobile device (e.g., smartphone, tablet) or other type of computing device, including those explained below with reference to FIG. 8. For example, the administrator device(s) 116 can include computing devices that display user interfaces for administrating or managing settings, configurations, pipelines, or data for the inter-network facilitation system 104. Moreover, the client device(s) 118 can include computing devices associated with (and/or operated by) users and corresponding user accounts for the inter-network facilitation system 104. In some embodiments, the client device(s) 118 include computing devices that display user interfaces for managing digital accounts (e.g., transferring assets, making payments, etc.) and/or portraying information regarding digital accounts (e.g., account transactions, account balances, etc.). Moreover, although FIG. 1 illustrates a single instance of the administrator device(s) 116 and the client device(s) 118, the environment 100 can include various numbers of administrator or client devices that communicate and/or interact with the inter-network facilitation system 104 and/or the unified transaction system 106.

In one or more embodiments, the client device(s) 118 include a client application. The client application can include instructions that (upon execution) cause the client device(s) 118 to perform various actions. For example, a user associated with an account can interact with the client application on the client device(s) 118 to access financial information, initiate a financial transaction, or modify account settings. In some embodiments, the administrator device(s) 116 also includes an administrator application similar to the client application. The client application may be a web application or a native application (e.g., a mobile application, a desktop application, etc.). In one or more implementations, the client application interfaces with the inter-network facilitation system 104 to provide digital content including graphical user interfaces to the client device(s) 118. In one or more implementations, the client application comprises a browser that renders graphical user interfaces on the display of the client device(s) 118.

In certain instances, the client device(s) 118 corresponds to one or more user accounts (e.g., user accounts stored at the server device(s) 102). For instance, a user of a client device can establish a user account with login credentials and various information corresponding to the user. In addition, the user accounts can include information regarding financial information and/or financial transaction information for users (e.g., name, telephone number, address, bank account number, credit amount, debt amount, financial asset amount), payment information, transaction history information, and/or contacts for financial transactions. In some embodiments, a user account can be accessed via multiple devices (e.g., multiple client devices) when authorized and authenticated to access the user account within the multiple devices.

The present disclosure utilizes client devices to refer to devices associated with such user accounts. In referring to a client device, the disclosure and the claims are not limited to communications with a specific device, but any device corresponding to a user account of a particular user. Accordingly, in using the term computing device, this disclosure can refer to any computing device corresponding to a user account of an inter-network facilitation system.

As shown, the environment 100 also includes third party processing server(s) 112. For example, in one or more embodiments, the inter-network facilitation system 104 utilizes the third party processing server(s) 112 to assist in processing transactions (e.g., managing a system of record, transferring funds between accounts, implementing transaction pipelines, etc.). The third party processing server(s) 112 can include a variety of server devices, as described below in relation to FIG. 8.

Furthermore, as illustrated in FIG. 1, the environment 100 also includes data management server(s) 114. The data management server(s) 114 can include integrated or external (e.g., third party) servers for storing, analyzing, and managing data volumes. For example, the data management server(s) 114 can include a variety of cloud/web-based systems for storing, processing, analyzing, and delivering transaction data. The data management server(s) 114 can include a variety of server devices, as described with regard to FIG. 8.

As further shown in FIG. 1, the environment 100 includes the network 108. As mentioned above, the network 108 can enable communication between components of the environment 100. In one or more embodiments, the network 108 may include a suitable network and may communicate using a various number of communication platforms and technologies suitable for transmitting data and/or communication signals, examples of which are described with reference to FIG. 8. Furthermore, although FIG. 1 illustrates the server device(s) 102, the transaction computer network devices 110a-110c, the third party processing server(s) 112, the data management server(s) 114, and the administrator device(s) 116 communicating via the network 108, the various components of the environment 100 can communicate and/or interact via other methods (e.g., the server device(s) 102 and the administrator device(s) 116 can communicate directly).

To illustrate an example, in one or more embodiments the transaction computer network devices 110a-110c initiate one or more transactions corresponding to an account managed by the inter-network facilitation system 104 (e.g., via the network 108). The unified transaction system 106 converts the transaction information from the transaction computer network devices 110a-110c from various network schemas to a unified transaction schema. Moreover, the unified transaction system 106 publishes a unified transaction stream that includes the transactions to other computer service systems (e.g., within the inter-network facilitation system 104). In addition, the unified transaction system 106 updates the unified transaction stream (e.g., by incrementing sequence identifiers for individual transactions as additional information becomes available) to provide an up-to-date, one read path for pertinent asset transaction information.

For example, the administrator device(s) 116 can include devices for detecting and managing elevated risk or fraud activities. The unified transaction system 106 can publish the unified transaction stream such that the administrator device(s) 116 can efficiently access digital information corresponding to the transactions in identifying fraudulent transactions or events. Similarly, the inter-network facilitation system 104 can access the unified transaction stream to modify assets of digital accounts and provide updated account information to the client device(s) 118. Moreover, the inter-network facilitation system 104 can access the unified transaction stream to update the data management server(s) 114 with digital transaction information corresponding to various user accounts. In addition, the inter-network facilitation system 104 can access the unified transaction stream to initiate additional transactions or modify transactions according to one or more transaction computer services (e.g., automatic transfers, automatic payment revisions, etc.).

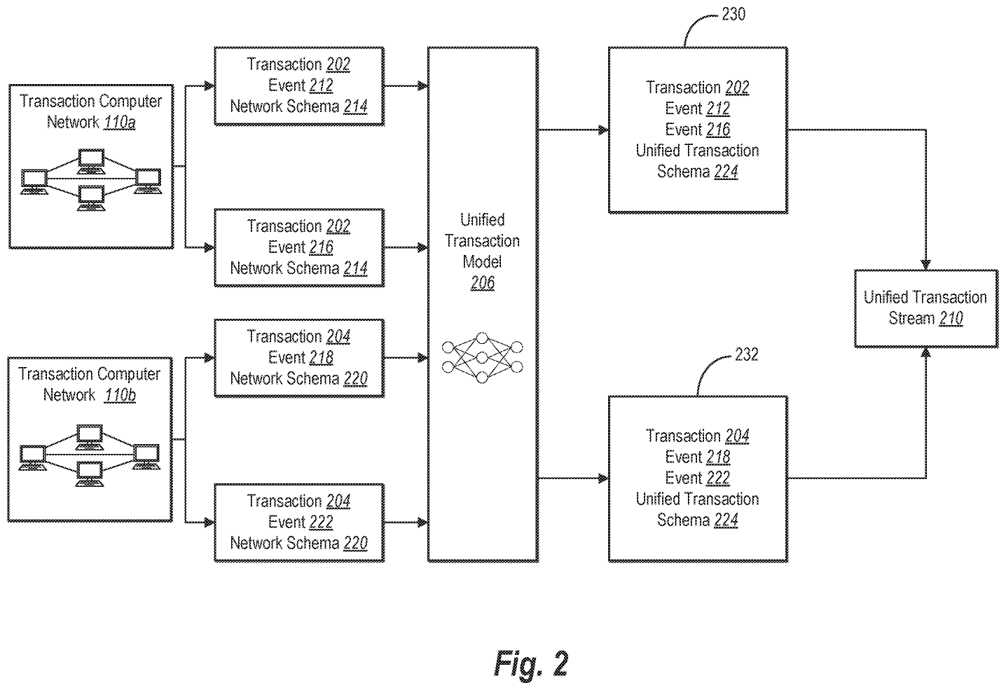

As just mentioned, in one or more embodiments, the unified transaction system 106 generates a unified transaction stream. For example, FIG. 2 illustrates the unified transaction system 106 generating a unified transaction stream 210 in accordance with one or more embodiments. Specifically, FIG. 2 shows the unified transaction system 106 generating the unified transaction stream 210 from transactions 202, 204 received from transaction computer networks 110a,110b utilizing network schemas 214, 220.

As shown, the unified transaction system 106 interacts with the transaction computer networks 110a, 110b. As discussed above, the transaction computer networks 110a, 110b can include a variety of computer networks for implementing different transactions for user accounts. The transaction computer networks 110a, 110b can include one or more computer devices for receiving transaction information (e.g., originating account, destination account, amount, type of transaction, etc.). Moreover, the transaction computer networks 110a, 110b can include various computer devices to collect and transmit transaction information from a vendor, individual, bank, or other entity.

With regard to FIG. 2, the transaction computer network 110a initiates a transaction 202 and the transaction computer network 110b initiates a transaction 204. In particular, the unified transaction system 106 receives transaction information from the transaction computer network 110a regarding the transaction 202, including an event 212, utilizing a network schema 214 corresponding to the transaction computer network 110a. For example, the event 212 can include an authorization event (e.g., authorization for a credit card transfer) for a credit card transaction. Moreover, the network schema 214 can include a standardized set of digital information corresponding to the transaction 202 from the transaction computer network 110a.

As shown, the transaction computer network 110a also transmits transaction information, including an event 216, corresponding to the transaction 202 utilizing the network schema 214. For example, the unified transaction system 106 receives the event 212 at a first time and receives the event 216 at a second time. For example, the event 216 can include a settlement event corresponding to the transaction 202 utilizing the network schema 214. Thus, over time the unified transaction system 106 receives a variety of different transmissions with digital information corresponding to the transaction 202.

Similarly, the transaction computer network 110b transmits transaction information to the unified transaction system 106. For example, the unified transaction system 106 receives transaction information, including the event 218, in a network schema 220 corresponding to the transaction computer network 110b (e.g., a different network schema than the network schema 214). For instance, the network schema 220 includes a particular standardized set of digital information in a format corresponding to the transaction computer network 110b.

Moreover, the transaction computer network 110b transmits additional transaction information regarding the transaction 204, including the event 222, to the unified transaction system 106. In particular, the unified transaction system 106 receives transaction information, including the event 222, in the network schema 220 corresponding to the transaction computer network 110b. Thus, over time, the unified transaction system 106 receives a variety of different transmissions regarding the transaction 204 from the transaction computer network 110b.

As illustrated, the unified transaction system 106 utilizes a unified transaction model 206 to convert the transactions received from the transaction computer networks 110a, 110b to a unified transaction schema 224. In particular, the unified transaction system 106 utilizes the unified transaction model 206 to generate unified transaction containers 230, 232 that include transaction information within the unified transaction schema 224.

As mentioned above, the unified transaction system 106 can utilize a variety of computer-implemented algorithms for the unified transaction model 206. For example, in some embodiments, the unified transaction model 206 includes a heuristic model that maps features, fields, or digital information from the network schema 214 and/or the network schema 220 to the unified transaction schema 224. To illustrate, the unified transaction system 106 can include a heuristic or ruled-based model that maps a first field having a first format to a new field having a new format. For example, the unified transaction system 106 can map text from a “class” field transmitted from the transaction computer network in the network schema 214 to a “type” field in the unified transaction schema 224. Similarly, the unified transaction system 106 can map a text from a first format, style, or standard (e.g., “auth”) to a new format, style, or standard (e.g., “authorization”). Similarly, the unified transaction system 106 can combine or divide fields and corresponding entries based on one or more rules or heuristics.

In some embodiments, the unified transaction model 206 includes a machine learning model, such as a decision tree (e.g., random forest model or XGBoost) or a neural network (e.g., a convolutional neural network, a recurrent neural network, or graph neural network) to map entries from the network schema 214 and/or the network schema 220 to the unified transaction schema 224. For example, the unified transaction system 106 can include a machine learning model that learns to extract or classify information corresponding to the unified transaction schema 224. To illustrate, the unified transaction system 106 can analyze a transmission from the transaction computer network 110a and extract/convert text that indicates an amount, time, or transaction type corresponding to the transaction 202.

For example, in one or more embodiments, the unified transaction system 106 generates an embedding (e.g., a feature vector) for a field or entry in a network schema utilizing an embedding neural network. The unified transaction system 106 also generates an embedding (e.g., a feature vector) for a field or entry in a unified transaction schema utilizing the embedding neural network. The unified transaction system 106 compares the feature vector for the network schema with the feature vector for the unified transaction schema within a feature space to map fields/entries from the network schema to the unified transaction schema.

Thus, as shown, the unified transaction system 106 converts information for the transaction 202 and the transaction 204 from the network schemas 214, 220 to the unified transaction schema 224. Indeed, as shown, the unified transaction system 106 generates unified transaction containers 230, 232 that combine information corresponding to the transactions 202, 204. For example, the first unified transaction container 230 includes information regarding the event 212 and the event 216 in the unified transaction schema 224. Moreover, the second unified transaction container 232 includes information regarding the event 218 and the event 222 in the unified transaction schema 224. Thus, the unified transaction system 106 converts and combines a variety of different digital transmissions over time to generate unified transaction containers in a single transaction schema.

Moreover, as illustrated, the unified transaction system 106 publishes transaction information for the transactions 202, 204 in the unified transaction schema 224 via the unified transaction stream 210. As mentioned above, the unified transaction stream 210 includes an updating collection of unified transaction containers providing information regarding transactions from various transaction computer networks. Thus, as shown, the unified transaction system 106 publishes the transaction 202 (in the first unified transaction container 230) and the transaction 204 (in the second transaction container 232) to the unified transaction stream 210.

Other computing devices can receive or subscribe to the unified transaction stream 210 to obtain pertinent information regarding transactions that originate across the transaction computer networks 110a, 110b. For example, computer service systems can establish rules or triggers to receive notifications regarding transactions based on particular features or characteristics that satisfy the rules or triggers. Thus, to illustrate, a fraud or risk service system can establish a rule to receive transaction information regarding any transaction over a certain amount.

Although FIG. 2 illustrates the unified transaction system 106 receiving transactions from two transaction computer networks 110a, 110b, the unified transaction system 106 can operate with additional transaction computer networks (e.g., three or more). Similarly, although the transactions information from the transaction computer networks 110a, 110b are illustrated as containing certain event information, the unified transaction system 106 can monitor a wide variety of transaction information over time (e.g., changes in status, amount, etc.) and/or other event information.

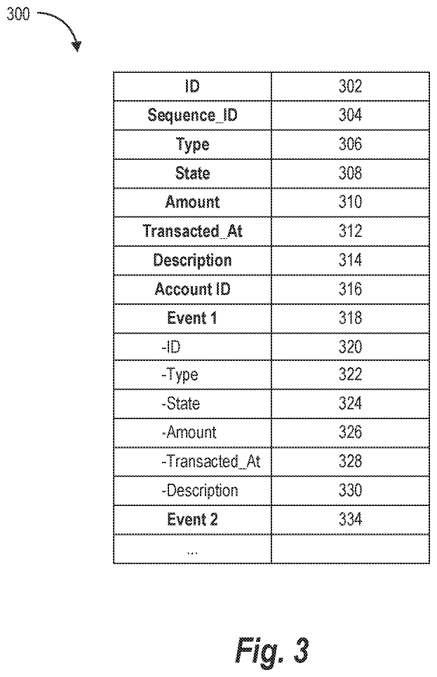

As mentioned, in one or more embodiments, the unified transaction system 106 converts transaction information from transaction computer networks to a unified transaction schema. In particular, the unified transaction system 106 can generate a unified transaction container having a unified transaction schema. For example, FIG. 3 illustrates a unified transaction container 300 in accordance with one or more embodiments.

In one or more embodiments, a unified transaction container includes a top level summary of a transaction and corresponding events. These events can serve as a historic record for a transaction. Moreover, the unified transaction system 106 can utilize the unified transaction container to reason about why state changes occurred. Indeed, the unified transaction container provides a one road path to reason about the current state of a transaction (and its history).

Moreover, in one or more embodiments, the unified transaction system 106 utilizes a unified transaction schema (e.g., common naming convention) across unified transaction containers. Thus, as illustrated in FIG. 3, the unified transaction container 300 includes a unified transaction identifier 302 (e.g., a consistent identifier such as a UUID to reference the transaction), a transaction version identifier 304 (e.g., an adjustable value that increases based on changes to one or more transactions corresponding to an account), a transaction type 306 (e.g., an indicator of the type or source of a transaction such as purchase or transfer), a transaction state 308 (e.g., a current state of the transaction such as processing, pending, settled, reversed, or rejected), a transaction amount 310 (e.g., an amount of assets corresponding to the transaction, such as an authorized amount and/or a settled amount), a transaction time 312 (e.g., a time a transaction is processed), a transaction description 314 (e.g., a description of the transaction), and a transaction account identifier 316 (e.g., an account number, title, or other identifier).

Notably, the transaction version identifier allows the unified transaction system 106 to upsert records without reverting newer changes. In particular, the unified transaction system 106 implements the unified transaction container 300 utilizing an optimistic locking approach that does not hold row locks between selecting and updating or deleting a row. Thus, the sequence_id allows a consumer to upsert a record when recording a new event.

In addition, the unified transaction container 300 includes information regarding multiple events 318, 334 corresponding to the transaction. For example, with regard to the event 318, the unified transaction container 300 includes an event identifier 320 (e.g., a consistent ID to reference the event or a character or field reflecting a separate event), an event type 322, an event state 324, an event amount 326, an event time 328, and an event description 330. Although FIG. 3 illustrates these fields only for the event 318, it will be appreciated that the unified transaction system 106 also includes corresponding fields for the event 334.

In one or more embodiments, the unified transaction system 106 records individualized/unique features for particular transaction computer networks within the event fields. Thus, for example, the unified transaction system 106 can include a “function” field particular to card transactions within the event 318. Accordingly, in one or more embodiments the unified transaction system 106 maintains the same naming conventions regardless of the transaction network and any specific/unique information for a particular transaction network can be isolated to event-specific fields or within a processor specific attribute.

Thus, as described above, the unified transaction system 106 can populate the unified transaction container 300 based on transaction information received from a transaction computer network. In particular, the unified transaction system 106 can receive transaction information in a network schema corresponding to the transaction network and convert the transaction information to populate the unified transaction container 300. Thus, for example, upon receiving a new transaction from a transaction computer network, the unified transaction system 106 generates a new transaction identifier and a new transaction version identifier. The unified transaction system 106 extracts and converts a transaction type from transaction information provided by the transaction computer network utilizing a unified transaction model. Similarly, the unified transaction system 106 extracts and converts a transaction state, an amount, a transaction time, a transaction description, and an account identifier from the transaction information corresponding to the transaction computer network and populates the unified transaction container 300 according to the unified transaction schema.

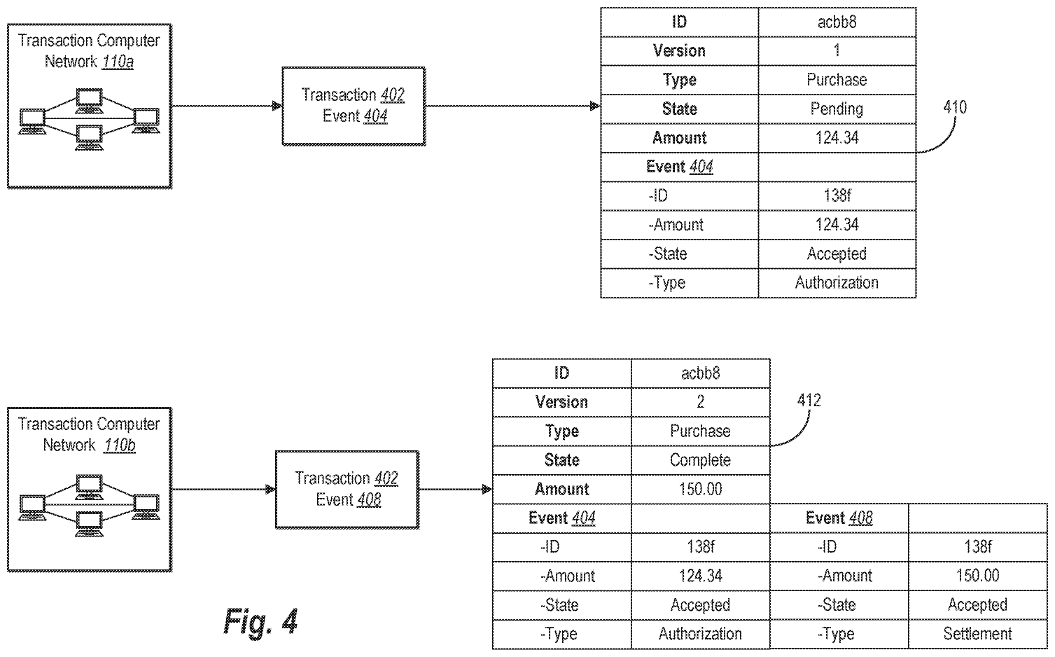

As mentioned above, in addition to generating unified transaction containers, the unified transaction system 106 can also update and modify unified transaction containers over time in response to additional events. For example, FIG. 4 illustrates the unified transaction system 106 generating a unified transaction container 410 and generating a modified unified transaction container 412 in accordance with one or more embodiments.

Specifically, as shown in FIG. 4, the unified transaction system 106 receives an event 404 corresponding to a transaction 402 from the transaction computer network 110a. As described above, the unified transaction system 106 converts the transaction information, including the event 404, to a unified transaction schema and generates a unified transaction container 410. Specifically, the unified transaction system 106 determines a unified transaction identifier, a transaction version identifier, a transaction type, a transaction state, and a transaction amount. Moreover, with regard to the event 404, the unified transaction system 106 determines an event identifier, an event amount, an event state, and an event type. Although not illustrated, the unified transaction system 106 publishes the unified transaction container 410 via a unified transaction stream.

In addition, as shown in FIG. 4, the unified transaction system 106 also receives additional transaction information, including an additional event 408, corresponding to the transaction 402 from the transaction computer network 110a. Indeed, the unified transaction system 106 receives the additional event 408 at a later time relative to receiving the event 404. In response, the unified transaction system 106 generates the modified unified transaction container 412 from the unified transaction container 410.

Specifically, the unified transaction system 106 converts the transaction information, including the event 408, to the unified transaction schema utilizing a unified transaction model. The unified transaction system 106 then updates the unified transaction container 410 utilizing converted transaction information in the unified transaction schema. Indeed, as illustrated in FIG. 4, the unified transaction system 106 modifies the transaction version identifier (e.g., from “1” to “2”). Moreover, the unified transaction system 106 changes the transaction state (e.g., from “pending” to “complete”). In addition, the unified transaction system 106 changes the transaction amount (e.g., because the event indicates an additional amount than the original authorization).

Furthermore, the unified transaction system 106 adds information regarding the event 408 in generating the modified unified transaction container 412. For example, the unified transaction system 106 generates a new event identifier, a new event amount, a new state, and a new type for the event 408. Notably, the unified transaction container contains all information about a given transaction over time. Accordingly, the unified transaction system 106 can implement the unified transaction container as an event carried state transfer. Moreover, the unified transaction system 106 can transmit the full state of the transaction via the unified event stream (e.g., in each message to a computer service system).

Indeed, the modified unified transaction container 412 includes all information regarding the transaction 402 in a single source. In particular, the modified unified transaction container 412 includes top-down information regarding the transaction 402, including the historical events corresponding to the transaction 402. Thus, the unified transaction system 106 can utilize the modified unified transaction container 412 to determine the current and historical state, purpose, and reason for a particular transaction. Indeed, in relation to the transaction 402, the unified transaction system 106 (and corresponding computer service systems) can process the modified unified transaction container 412 to determine that the transaction 402 included an initial authorization (e.g., an initial credit card authorization at a restaurant) for 124.34 and an ultimate settlement for 150.00. Moreover, the unified transaction system 106 can further update and modify the unified transaction container 412 in response to receiving any additional updates or events.

Although FIG. 4 illustrates a particular example form of a unified transaction container over time, the unified transaction system 106 can utilize a variety of fields or forms for unified transaction containers. For example, in one or more embodiments, the unified transaction system 106 utilizes the following fields or format for a unified transaction container in response to an initial authorization event for a transaction:

```
{
  “id”: “acbb8e1c-aa7b-43ce-a237-19beb23c6”,
  “version”: 1,
  “type”: “purchase”,
  “amount”: 124.34,
  “amounts”: {
  “authorized”: 124.34,
  “settled”: null
  },
  “description”: “Conference Room B”,
  “state”: “pending”,
  “transacted_at”: “2020-12-18T05:33:43Z”,
  “provider”: “provider 1”,
  “account”: {
    “id”: “3acf14d6-4467-4c45-aaf5-6a993e0e0”,
    “status”: “active”,
    “type”: “checking”
  },
  “card”: {
    “id”: “7943e967-d073-403f-81df-5ea054cb0 ”,
    “status”: “active”,
    “last4”: “1234”,
    “expiration”: “10/25”
  },
  “merchant”: {
    “id”: “8e0e9eb8-5c29-400a-95d1-8d516dcfd”,
    “name”: “Conference Room B”
  },
  “events”: [
    {
      “id”: “138f2291-6378-49e0-8610-9369bc8ef”,
      “amount”: 124.34,
      “description”: “Conference Room B”,
      “function”: “advice”,
      “state”: “accepted”,
      “transacted_at”: “2020-12-18T05:33:43Z”,
      “type”: “authorization”
    }
]
```

Similarly, in one or more embodiments, the unified transaction system 106 utilizes the following fields or formats for a modified unified transaction container in response to a subsequent settlement event for the transaction:

```
{
  “id”: “acbb8e1c-aa7b-43ce-a237-19beb23c6”,
  “version”: 2,
  “type”: “purchase”,
  “amount”: 150.00,
  “amounts”: {
    “authorized”: 124.34,
    “settled”: 150.00
  },
  “description”: “Conference Room B”,
  “state”: “complete”,
  “transacted_at”: “2020-12-18T05:33:43Z”,
  “provider”: “provider 1”,
  “account”: {
    “id”: “3acf14d6-4467-4c45-aaf5-6a993e0e0”,
    “status”: “active”,
    “type”: “checking”
  },
  “card”: {
    “id”: “7943e967-d073-403f-81df-5ea054cb0 ”,
    “status”: “active”,
    “last4”: “1234”,
    “expiration”: “10/25”
  },
  “merchant”: {
    “id”: “8e0e9eb8-5c29-400a-95d1-8d516dcfd”,
    “name”: “Conference Room B”
  },
  “events”: [
    {
      “amount”: 124.34,
      “description”: “Conference Room B”,
      “function“: “request”,
      “state”: “accepted”,
      “transacted_at”: “2020-12-18T05:33:43Z”,
      “type”: “authorization”
    },
    {
      “amount”: 150.00,
      “description”: “Conference Room B”,
      “function”: “advice”,
      “state”: “accepted”,
      “transacted_at”: “2020-12-20T00:00:00Z”,
      “type”: “settlement”
    }
  ]
```

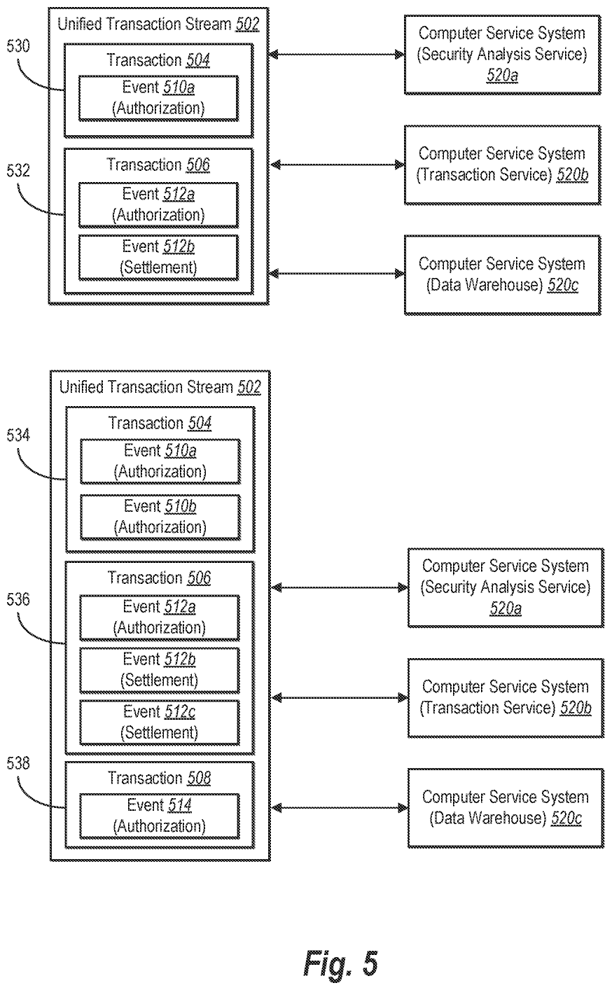

As mentioned above, in one or more embodiments, the unified transaction system 106 distributes unified transaction containers in a unified transaction stream to a plurality of computer service systems over time. For example, FIG. 5 illustrates the unified transaction system 106 publishing and modifying a unified transaction stream 502 to computer service systems 520a-520c.

In particular, FIG. 5 illustrates the unified transaction system 106 publishing a unified transaction stream 502 (at a first time) that includes a first unified transaction container 530 and a second unified transaction container 532. As shown, the first unified transaction container 530 includes transaction information in a unified transaction schema for a first transaction 504 having an event 510a (e.g., an authorization event). Similarly, the second unified transaction container 532 includes transaction information in the unified transaction schema for a second transaction 506 having events 512a, 512b (e.g., an authorization event and a settlement event).

The unified transaction system 106 publishes the unified transaction stream 502 to a first computer service system 520a (e.g., a security analysis computer service system), a second computer service system 520b (e.g., a transaction computer service system), and/or a third computer service system 520c (e.g., a data warehouse computer service system). For example, first computer service system 520a can include a security analysis computer service system that generates risk/fraud predictions for the inter-network facilitation system 104. To illustrate, the first computer service system 520a includes one or more machine learning models to predict fraudulent devices. Thus, for example, the first computer service system 520a can include systems that implement machine learning models to predict fraudulent transactions, fraudulent access to client accounts, fraudulent transaction disputes, or other fraudulent conduct. For example, in one or more embodiments, the first computer service system 520a includes models and systems described in UTILIZING A FRAUD PREDICTION MACHINE-LEARNING MODEL TO INTELLIGENTLY GENERATE FRAUD PREDICTIONS FOR NETWORK TRANSACTIONS, U.S. application Ser. No. 17/546,410, filed Dec. 9, 2021; GENERATING A FRAUD PREDICTION UTILIZING A FRAUD-PREDICTION MACHINE-LEARNING MODEL, U.S. application Ser. No. 17/545,890, filed Dec. 8, 2021; or UTILIZING MACHINE-LEARNING MODELS TO DETERMINE TAKE-OVER SCORES AND INTELLIGENTLY SECURE DIGITAL ACCOUNT FEATURES, U.S. application Ser. No. 17/574,144, filed Jan. 12, 2022, which are incorporated herein by reference in their entirety.

Similarly, the first computer service system 520a can include computer systems that generate risk predictions (e.g., risks for digital accounts and corresponding client devices). To illustrate, the first computer service system 520a can include a risk prediction model that generates activity scores and predicted base limit values for digital accounts as described in GENERATING USER INTERFACES COMPRISING DYNAMIC BASE LIMIT VALUE USER INTERFACE ELEMENTS DETERMINED FROM A BASE LIMIT VALUE MODEL, U.S. application Ser. No. 17/519,129, filed Nov. 4, 2021, and incorporated by reference herein in its entirety.

The first computer service system 520a can access the unified transaction stream 502 to generate one or more predictions. For example, the first computer service system 520a can access the unified transaction stream 502 and utilizes the unified transaction containers 530, 532 to predict whether one or more transactions or client devices are fraudulent. Similarly, the first computer service system 520a can access the unified transaction stream 502 to determine whether a client device challenging a transaction is accurate or fraudulent. The first computer service system 520a can analyze the unified transaction stream 502 to identify up-to-date events and transaction patterns to generate fraud/risk predictions for digital accounts and client devices.

As shown, the second computer service system 520b can include a transaction computer service system. For example, the transaction computer service system can initiate additional transactions based on the unified transaction stream 502. To illustrate, in one or more implementations the unified transaction system 106 implements a “roundup” program that initiates a process that rounds each transaction up to a particular value (e.g., the next whole dollar, the next five dollar increment, or the next increment of whole ten dollars). In such a program, the unified transaction system 106 publishes the unified transaction stream 502, and the second computer service system 520b access the unified transaction stream 502 to identify transactions and transaction amounts. Upon identifying transactions that are not “rounded,” the second computer service system 520b initiates a post-processing process and/or initiates an additional transaction to round up the transaction to the particular value. Thus, for a transaction of 9.74, the unified transaction system 106 can initiate a post-processing protocol/transaction for 0.26 so that the total transaction is 10.00. Moreover, the unified transaction system 106 can transfer the remaining 0.26 to a desired location (e.g., a credit, savings, or retirement account).

Moreover, as shown, the unified transaction system 106 can interact with a third computer service system 520c, such as a data warehouse computer service system. For example, the data warehouse computer service system can store, manage, update, and retrieve digital data corresponding to the inter-network facilitation system 104. To illustrate, the data warehouse computer service system can subscribe to the unified transaction stream 502 and log transactions and transactions events as the unified transaction system 106 publishes transactions to the unified transaction stream 502. Thus, the data warehouse computer service system can utilize the unified transaction stream as a unified source for generating an accurate data warehouse of transactions for the inter-network facilitation system 104.

Although not illustrated, the unified transaction system 106 can also interact with a variety of additional computer service systems. For example, in some embodiments, the unified transaction system 106 interacts with a machine learning computer service system that gathers training data, trains machine learning models, and implements machine learning models. Thus, the machine learning computer service system can subscribe to the unified transaction stream to extract training data for pertinent machine learning models (e.g., particular types or categories of transactions, or transactions satisfying certain criteria). Moreover, the machine learning computer service system can access the unified transaction stream 502 to implement various machine learning models. For example, in one or more embodiments, the machine learning computer service system includes a feature store and/or machine learning system described in TRAINING AND IMPLEMENTING MACHINE-LEARNING MODELS UTILIZING MODEL CONTAINER WORKFLOWS, U.S. application Ser. No. 17/578,222, filed Jan. 18, 2022, or GENERATING AND MAINTAINING A FEATURE FAMILY REPOSITORY OF MACHINE LEARNING FEATURES, U.S. application Ser. No. 17/558,375, filed Dec. 21, 2021, which are incorporated by reference herein in their entirety.

Moreover, in one or more embodiments the unified transaction system 106 provides unified transaction streams to digital asset modification computer service systems. For example, the digital asset modification computer service system can modify digital assets corresponding to digital accounts. The digital asset modification computer service system can monitor transactions via the unified transaction stream 502 and update a digital account to reflect asset changes resulting from the transactions. Moreover, the inter-network facilitation system 104 can provide updated digital account information to one or more client devices. In some embodiments, the asset modification computer service system modifies a ledger, system of record, or other record of transactions corresponding to digital accounts.

In some implementations, the unified transaction system 106 provides unified transaction streams to administrative computer service systems. For example, the unified transaction system 106 can provide the unified transaction streams to administrative devices for generating dashboards or reports regarding transaction information. Thus, the unified transaction system 106 can utilize the unified transaction streams to generate real-time, updated dashboards to administrative devices to make decisions regarding implementation of the intern-network facilitation system 104. The unified transaction system 106 can also utilize a computer service system that includes a risk/decision platform as described by DIGITAL POLICY CRITERIA INTEGRATION FOR MAKING DETERMINATIONS WITHIN AN INTER-NETWORK FACILITATION SYSTEM, U.S. patent application Ser. No. 17/664,829, filed May 24, 2022, which is incorporated by reference herein in its entirety.

In one or more embodiments, the unified transaction system 106 provides the unified transactions streams to third-party computer service systems. For example, the unified transaction system 106 can provide unified transaction streams to various subscribing entities, such as computer service systems for one or more banking institutions.

As mentioned above, the unified transaction system 106 can implement the unified transaction stream 502 in a variety of approaches. For example, the unified transaction system 106 can utilize a push, pull, or subscription approach. Thus, for example, in some embodiments, the unified transaction system 106 transmits the unified transaction stream 502 to one or more of the computer service systems 520a as the unified transaction stream 502 is updated. In some implementations, the unified transaction system 106 publishes the unified transaction stream 502 by transmitting all or a portion of the unified transaction stream 502 in response to requests from the computer service systems 520a-520c (e.g., posts the unified transaction stream 502 to a database and allows the computer service systems 520a-520c to request or query the database). In some embodiments, the unified transaction system 106 utilizes a subscription approach that monitors triggering conditions and transmits all or a portion of the unified transaction stream 502 to the computer service systems 520a-520c upon detecting that the triggering conditions are satisfied.

As illustrated, the unified transaction system 106 also publishes (at a second time) the unified transaction stream 502 with modified unified transaction containers 534, 536 and a new unified transaction container 538. For example, FIG. 5 illustrates the unified transaction system 106 generating a modified unified transaction container 534 with the event 510a (e.g., an authorization), and a new event 510b (e.g., an additional authorization). Similarly, the unified transaction system 106 generates a modified unified transaction container 536 with the event 512a (e.g., an authorization), the event 512b (e.g., a settlement), and the new event 512c (e.g., an additional settlement). Furthermore, the unified transaction system 106 generates a new unified transaction container 538 for a new transaction 508 with a new event 514.

The unified transaction system 106 provides the unified transaction stream 502 with the updated/new unified transaction containers to the computer service systems 520a-520c. Thus, the unified transaction stream 502 provides a real-time, up-to-date resource for identifying current and historical information regarding transactions of the inter-network facilitation system 104.

As mentioned above, the unified transaction system 106 can utilize a variety of different unified transaction containers in generating a unified transaction stream. For example, the following unified transaction container illustrates a transaction with multiple incremental authorizations (such as hotel or rental car purchases that utilize multiple authorization processes):

```
{
  “id”: “badd6e1c-aa7b-43ce-a237-19beb23c6”,
  “version”: 5,
  “type”: “purchase”,
  “amount”: 431.51,
  “amounts”: {
    “authorized”: 550.74,
    “settled”: 431.51
  },
  “description”: “STORE 123456 OKLAHOMA”,
  “state”: “complete”,
  “transacted_at”: “2020-12-18T05:33:43Z”,
  “provider”: “provider 1”,
  “account”: {
    “id”: “3acf14d6-4467-4c45-aaf5-6a993e0e0”,
    “status”: “active”,
    “type”: “checking”
  },
  “card”: {
    “id”: “7943e967-d073-403f-81df-5ea054cb0”,
    “status”: “active”,
    “last4”: “1234”,
    “expiration”: “10/25”
  },
  “merchant”: {
    “id”: “8e0e9eb8-5c29-400a-95d1-8d516dcfd”,
    “name”: “STORE 123456 OKLAHOMA”
  },
  “events”: [
    {
      “amount”: 124.49,
      “description”: “STORE 123456 OKLAHOMA”,
      “function”: “request”,
      “state”: “accepted”,
      “transacted_at”: “2021-02-19T05:33:43Z”,
      “type”: “authorization”
    },
    {
      “amount”: 133.44,
      “description”: “STORE 123456 OKLAHOMA”,
      “function”: “request”,
      “state”: “accepted”,
      “transacted_at”: “2021-02-22T05:33:43Z”,
      “type”: “authorization”
    },
    {
      “amount”: 86.79,
      “description”: “STORE 123456 OKLAHOMA”,
      “function”: “request”,
      “state”: “accepted”,
      “transacted_at”: “2021-02-26T05:33:43Z”,
      “type”: “authorization”
    },
    {
      “amount”: 206.02,
      “description”: “STORE 123456 OKLAHOMA”,
      “function”: “request”,
      “state”: “accepted”,
      “transacted_at”: “2021-02-27T05:33:43Z”,
      “type”: “authorization”
    },
    {
      “amount”: 431.51,
      “description”: “STORE 123456 OKLAHOMA”,
      “function”: “advice”,
      “state”: “accepted”,
      “transacted_at”: “2020-03-01T00:00:00Z”,
      “type”: “settlement”
    }
  ]
}
```

Similarly, the following unified transaction container illustrates a transaction with a single authorization event but multiple different settlement events:

```
{
  “id”: “baad7e1c-sb9c-24ce-b334-20acab43c7”,
  “version”: 4,
  “type”: “purchase”,
  “amount”: 98.00,
  “amounts”: {
    “authorized”: 98.00,
    “settled”: 98.00
  },
  “description”: “STORE.COM 12345 ARUS”,
  “state”: “complete”,
  “transacted_at”: “2021-01-26T05:33:43Z”,
  “provider”: “provider 1”,
  “account”: {
    “id”: “3acf14d6-4467-4c45-aaf5-6a993e0e0”,
    “status”: “active”,
    “type”: “checking”
  },
  “card”: {
    “id”: “9555b988-c003-400f-800f-9aa004cb0 ”,
    “status”: “active”,
    “last4”: “1234”,
    “expiration”: “10/25”
  },
  “merchant”: {
    “id”: “8e999eb6-5c29-400a-95d1-8d516dcfd”,
    “name”: “STORE.COM 12345 ARUS”
  },
  “events”: [
    {
      “amount”: 98.00,
      “description”: “STORE.COM 12345 ARUS”,
      “function”: “request”,
      “state”: “accepted”,
      “transacted_at”: “2021-01-26T05:33:43Z”,
      “type”: “authorization”
    },
    {
      “amount”: 61.92,
      “description”: “STORE.COM 12345 ARUS”,
      “function”: “advice”,
      “state”: “accepted”,
      “transacted_at”: “2021-02-01T05:33:43Z”,
      “type”: “settlement”
    },
    {
      “amount”: 16.55,
      “description”: “STORE.COM 12345 ARUS”,
      “function”: “advice”,
      “state”: “accepted”,
      “transacted_at”: “2021-02-01T05:33:43Z”,
      “type”: “settlement”
    },
    {
      “amount”: 19.53,
      “description”: “STORE.COM 12345 ARUS”,
      “function”: “advice”,
      “state”: “accepted”,
      “transacted_at”: “2020-02-02T00:00:00Z”,
      “type”: “settlement”
    }
  ]
}
```

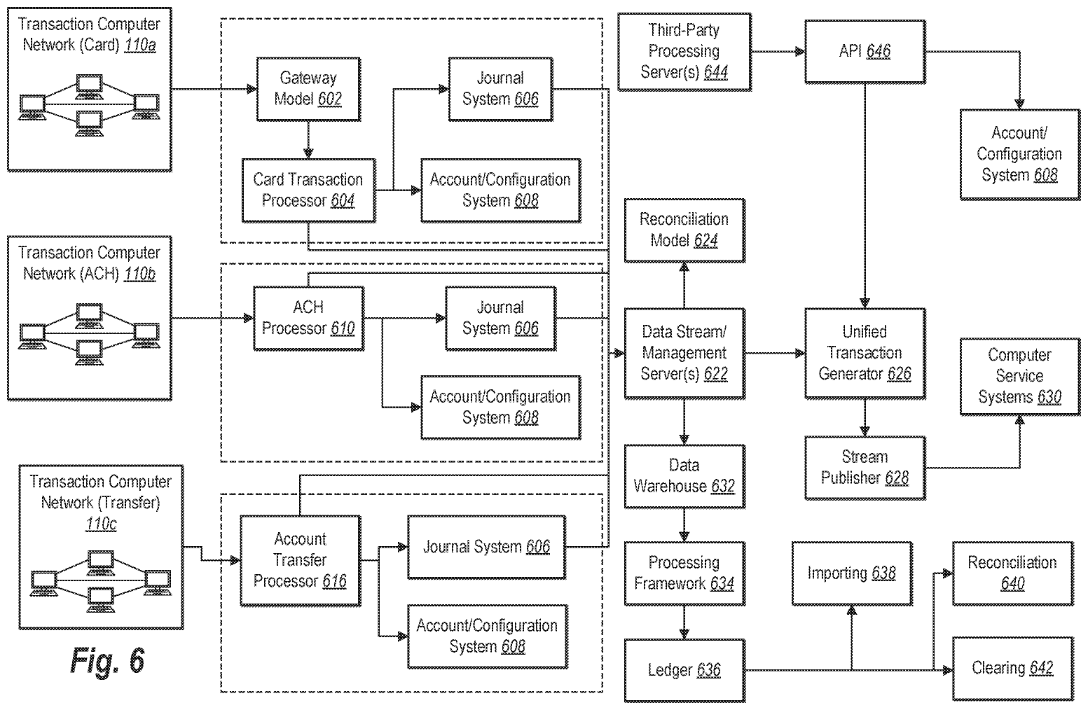

In one or more embodiments, the unified transaction system 106 operates within a larger platform of the inter-network facilitation system 104. For example, FIG. 6 illustrates a platform in which the unified transaction system 106 operates in accordance with one or more embodiments. Indeed, FIG. 6 illustrates the transaction computer networks 110a-110c providing transaction information corresponding to different transaction types (e.g., card, ACH, or transfer transactions). The inter-network facilitation system 104 receives and processes this transaction information utilizing a variety of computer implemented models and procedures.

For example, as shown in FIG. 6, the inter-network facilitation system 104 utilizes a gateway model 602 to analyze transaction information from the transaction computer network 110a (e.g., a card transaction computer network). The gateway model 602 performs an initial analysis of the transaction information (e.g., accepts or rejects the transaction based on gateway criteria). Moreover, the inter-network facilitation system 104 also analyzes the transaction information utilizing the card transaction processor 604. In one or more embodiments, the card transaction processor 604 extracts and analyzes information for the inter-network facilitation system 104. For example, in some embodiments, the card transaction processor 604 transforms and converts information from the transaction computer network 110a for further analysis within the inter-network facilitation system 104. In some embodiments, the card transaction processor 604 assists in converting a network schema to a unified transaction schema, as described above (e.g., utilizing a unified transaction model).

As shown, the card transaction processor 604 also communicates with a journal system and an account/configuration system 608. For example, the account/configuration system 608 can verify that the inter-network facilitation system 104 has an account corresponding to the transaction information, whether the account has funds for the transaction, etc. Moreover, the account/configuration system 608 can determine configurations corresponding to the transaction (e.g., configurations that define pipelines, procedures within the inter-network facilitation system 104 for implementation the transaction). The journal system 606 tracks and manages asset movement for a transaction. For example, the journal system 606 records asset movement for accounts corresponding to transactions.

As shown, the journal system 606 and/or the card transaction processor 604 emit transaction information, such as events, to data management server(s) 622. The data management server(s) 622 can store, process, provide, and/or report transaction information. For example, as illustrated, the data management server(s) 622 can provide transaction information to a reconciliation model 624 (e.g., to reconcile transaction information with the transaction computer network 110a). Similarly, the data management server(s) 622 can provide transaction information to a data warehouse 632 for further processing (via the processing framework 634) entry into a ledger 636 (or system of record), and further analysis via importing 638 (e.g., bank/entity importing), reconciliation 640 (e.g., reconciliation of the ledger or system of record), or clearing 642 processes/models. Indeed, in one or more embodiments, the journal system 606 exports transaction information (via the data management server(s) 622, and the data warehouse 632) to maintain a system of record for transactions across the inter-network facilitation system 104.

The inter-network facilitation system 104 performs similar functions with regard to the transaction computer networks 110b, 110c (e.g., ACH transaction computer networks and transfer transaction computer networks). As shown, the inter-network facilitation system 104 utilizes an ACH processor 610 to process transaction information from the transaction computer network 110b (e.g., similar to the card transaction processor 604). Moreover, the inter-network facilitation system 104 utilizes the journal system 606 and the account/configuration system 608 to transmit transaction events to the data management server(s) 622. Similarly, the inter-network facilitation system 104 utilizes an account transfer processor 616 to process transaction information from the transaction computer network 110c (e.g., similar to the card transaction processor 604). Moreover, the inter-network facilitation system 104 utilizes the journal system 606 and the account/configuration system 608 to transfer transaction events corresponding to the transaction computer network 110c to the data management server(s) 622.

As shown in FIG. 6, the inter-network facilitation system 104 utilizes a unified transaction generator 626 (e.g., the unified transaction model of the unified transaction system 106) to generate unified transaction containers for individual transactions. As shown, the unified transaction generator 626 can combine transaction information from different transaction computer networks 110a-110c. As shown, the unified transaction generator 626 can also generate unified transaction containers from transaction information received from third-party processing server(s) 644.

For example, the third-party processing server(s) 644 can work in conjunction with the inter-network facilitation system 104 to provide additional bandwidth, throughput, or redundancy in processing transactions from the transaction computer networks 110a-110c. In some implementations, the third-party processing server(s) 644 receive and process transaction information. The inter-network facilitation system 104 can utilize an API 646 to import the transaction information (and utilize the account/configuration system 608 to verify account information and obtain configuration information necessary to feed the transaction information through the remainder of the inter-network facilitation system 104). The unified transaction generator 626 receives this transaction information and generates unified transaction containers (e.g., by converting the transaction information, if necessary, and populating unified transaction containers with pertinent information extracted from the transaction information).

Moreover, the inter-network facilitation system 104 publishes a unified transaction stream utilizing a stream publisher 628. As show, the stream publisher 628 provides the unified transaction stream to computer service systems 630. Thus, the unified transaction stream can include information from the transaction computer networks 110a-110c and information from the third-party processing server(s) 644.

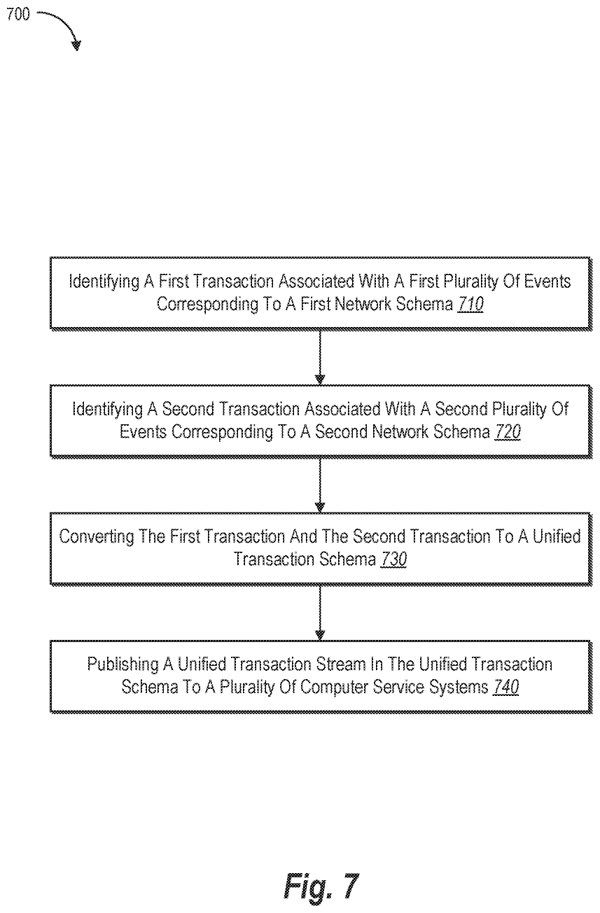

FIGS. 1-6, the corresponding text, and the examples provide a number of different methods, systems, devices, and non-transitory computer-readable media of the unified transaction system 106. In addition to the foregoing, one or more embodiments can also be described in terms of flowcharts comprising acts for accomplishing the particular result, as shown in FIG. 7. The series of acts illustrated in FIG. 7 may be performed with more or fewer acts. Further, the illustrated acts may be performed in different orders. Additionally, the acts described herein may be repeated or performed in parallel with one another or in parallel with different instances of the same or similar acts. A non-transitory computer-readable medium can comprise instructions that, when executed by one or more processors, cause a computing device to perform the acts of FIG. 7. In some embodiments, a system can be configured to perform the acts of FIG. 7. Alternatively, the acts of FIG. 7 can be performed as part of a computer-implemented method.

FIG. 7 illustrates a flowchart of a series of acts 700 for generating a unified transaction stream in accordance with one or more embodiments. The series of acts 700 includes an act 710 of identifying a first transaction associated with a first plurality of events corresponding to a first network schema; an act 720 of identifying a second transaction associated with a second plurality of events corresponding to a second network schema; an act 730 of converting the first transaction and the second transaction to a unified transaction schema; and an act 740 of publishing a unified transaction stream in the unified transaction schema to a plurality of computer service systems.

For example in one or more implementations, the acts 710-740 include: identifying, via a first transaction computer network, a first transaction associated with a first plurality of events corresponding to a first network schema; identifying, via a second transaction computer network, a second transaction associated with a second plurality of events corresponding to a second network schema; converting, utilizing a unified transaction model, the first transaction comprising the first plurality of events corresponding to the first network schema and the second transaction comprising the second plurality of events corresponding to the second network schema to a unified transaction schema; and publishing a unified transaction stream comprising the first transaction, the first plurality of events, the second transaction, and the second plurality of events in the unified transaction schema to a plurality of computer service systems.

In one or more implementations, the series of acts 700 includes identifying, via the first transaction computer network, an additional event corresponding to the first network schema for the first transaction; and converting, utilizing the unified transaction model, the additional event from the first network schema to the unified transaction schema. Moreover, in one or more implementations, the series of acts 700 includes publishing the additional event via the unified transaction stream.

In addition, in one or more implementations, the series of acts 700 includes converting the first transaction to the unified transaction schema further by generating a unified transaction container comprising a unified transaction identifier, a transaction version identifier, a transaction state, and event identifiers reflecting the first plurality of events.

In one or more implementations, the series of acts 700 includes in response to identifying the additional event, modifying the unified transaction container by generating a modified transaction version identifier, generating a modified transaction state, and modifying the event identifiers to include the additional event and the first plurality of events.

Further, in one or more implementations, the series of acts 700 includes publishing the unified transaction stream by transmitting the first plurality of events and the second plurality of events to at least one of a: computer-implemented security analysis system, a digital data warehousing system, a transaction system, or a digital asset modification system.

Moreover, in one or more implementations, the series of acts 700 includes identifying, via the first transaction computer network, the first transaction associated with the first plurality of events corresponding to the first network schema by identifying a card transaction, via a card transaction computer network, associated with an authorization event and a settlement event corresponding to a card network schema; and converting the first transaction to the unified transaction schema by converting, utilizing the unified transaction model, the authorization event and the settlement event to a unified transaction container comprising a first event identifier indicating the authorization event and a second event identifier indicating the settlement event.

In one or more implementations, the series of acts 700 includes identifying, via the second transaction computer network, the second transaction associated with the second plurality of events corresponding to the second network schema by identifying an ACH transaction, via an ACH transaction computer network, associated with an authorization event and a settlement event corresponding to an ACH network schema; and converting the first transaction to the unified transaction schema by converting, utilizing the unified transaction model, the authorization event and the settlement event to a unified transaction container comprising a first event identifier indicating the authorization event and a second event identifier indicating the settlement event.

Furthermore, in one or more implementations, the series of acts 700 includes identifying the first plurality of events by identifying a first settlement event and a second settlement event and converting the first transaction by converting, utilizing the unified transaction model, the first settlement event and the second settlement event to a unified transaction container comprising a first settlement identifier indicating the first settlement event and a second settlement identifier indicating the second settlement event.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

Computer-readable media can be any available media that can be accessed by a general purpose or special purpose computer system, including by one or more servers. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, virtual reality devices, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 8 illustrates, in block diagram form, an exemplary computing device 800 that may be configured to perform one or more of the processes described above. One will appreciate that the unified transaction system 106 (or the inter-network facilitation system 104) can comprise implementations of a computing device, including, but not limited to, the devices or systems illustrated in the previous figures. As shown by FIG. 8, the computing device can comprise a processor 802, memory 804, a storage device 806, an I/O interface 808, and a communication interface 810. In certain embodiments, the computing device 800 can include fewer or more components than those shown in FIG. 8. Components of computing device 800 shown in FIG. 8 will now be described in additional detail.

In particular embodiments, processor(s) 802 includes hardware for executing instructions, such as those making up a computer program. As an example, and not by way of limitation, to execute instructions, processor(s) 802 may retrieve (or fetch) the instructions from an internal register, an internal cache, memory 804, or a storage device 806 and decode and execute them.

The computing device 800 includes memory 804, which is coupled to the processor(s) 802. The memory 804 may be used for storing data, metadata, and programs for execution by the processor(s). The memory 804 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. The memory 804 may be internal or distributed memory.

The computing device 800 includes a storage device 806 includes storage for storing data or instructions. As an example, and not by way of limitation, storage device 806 can comprise a non-transitory storage medium described above. The storage device 806 may include a hard disk drive (“HDD”), flash memory, a Universal Serial Bus (“USB”) drive or a combination of these or other storage devices.

The computing device 800 also includes one or more input or output (“I/O”) interface 808, which are provided to allow a user (e.g., requester or provider) to provide input to (such as user strokes), receive output from, and otherwise transfer data to and from the computing device 800. These I/O interface 808 may include a mouse, keypad or a keyboard, a touch screen, camera, optical scanner, network interface, modem, other known I/O devices or a combination of such I/O interface 808. The touch screen may be activated with a stylus or a finger.

The I/O interface 808 may include one or more devices for presenting output to a user, including, but not limited to, a graphics engine, a display (e.g., a display screen), one or more output providers (e.g., display providers), one or more audio speakers, and one or more audio providers. In certain embodiments, the I/O interface 808 is configured to provide graphical data to a display for presentation to a user. The graphical data may be representative of one or more graphical user interfaces and/or any other graphical content as may serve a particular implementation.

The computing device 800 can further include a communication interface 810. The communication interface 810 can include hardware, software, or both. The communication interface 810 can provide one or more interfaces for communication (such as, for example, packet-based communication) between the computing device and one or more other computing devices 800 or one or more networks. As an example, and not by way of limitation, communication interface 810 may include a network interface controller (“NIC”) or network adapter for communicating with an Ethernet or other wire-based network or a wireless NIC (“WNIC”) or wireless adapter for communicating with a wireless network, such as a WI-FI. The computing device 800 can further include a bus 812. The bus 812 can comprise hardware, software, or both that couples components of computing device 800 to each other.

FIG. 9 illustrates an example network environment 900 of the inter-network facilitation system 104. The network environment 900 includes a client device 906 (e.g., a computing device, such as the client device(s) 118 or the administrator device(s) 116), an inter-network facilitation system 104, and a third-party system 908 connected to each other by a network 904. Although FIG. 9 illustrates a particular arrangement of the client device 906, the inter-network facilitation system 104, the third-party system 908, and the network 904, this disclosure contemplates any suitable arrangement of client device 906, the inter-network facilitation system 104, the third-party system 908, and the network 904. As an example, and not by way of limitation, two or more of client device 906, the inter-network facilitation system 104, and the third-party system 908 communicate directly, bypassing network 904. As another example, two or more of client device 906, the inter-network facilitation system 104, and the third-party system 908 may be physically or logically co-located with each other in whole or in part.

Moreover, although FIG. 9 illustrates a particular number of client devices 906, inter-network facilitation systems 104, third-party systems 908, and networks 904, this disclosure contemplates any suitable number of client devices 906, inter-network facilitation system 104, third-party systems 908, and networks 904. As an example, and not by way of limitation, network environment 900 may include multiple client devices 906, inter-network facilitation system 104, third-party systems 908, and/or networks 904.

This disclosure contemplates any suitable network 904. As an example, and not by way of limitation, one or more portions of network 904 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 904 may include one or more networks 904.

Links may connect client device 906, inter-network facilitation system 104 (e.g., which hosts the unified transaction system 106), and third-party system 908 to network 904 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 900. One or more first links may differ in one or more respects from one or more second links.

In particular embodiments, the client device 906 may be an electronic device including hardware, software, or embedded logic components or a combination of two or more such components and capable of carrying out the appropriate functionalities implemented or supported by client device 906. As an example, and not by way of limitation, a client device 906 may include any of the computing devices discussed above in relation to FIG. 9. A client device 906 may enable a network user at the client device 906 to access network 904. A client device 906 may enable its user to communicate with other users at other client devices 906.

In particular embodiments, the client device 906 may include a requester application or a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at the client device 906 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device 906 one or more Hyper Text Markup Language (“HTML”) files responsive to the HTTP request. The client device 906 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, inter-network facilitation system 104 may be a network-addressable computing system that can interface between two or more computing networks or servers associated with different entities such as financial institutions (e.g., banks, credit processing systems, ATM systems, or others). In particular, the inter-network facilitation system 104 can send and receive network communications (e.g., via the network 904) to link the third-party-system 908. For example, the inter-network facilitation system 104 may receive authentication credentials from a user to link a third-party system 908 such as an online bank account, credit account, debit account, or other financial account to a user account within the inter-network facilitation system 104. The inter-network facilitation system 104 can subsequently communicate with the third-party system 908 to detect or identify balances, transactions, withdrawal, transfers, deposits, credits, debits, or other transaction types associated with the third-party system 908. The inter-network facilitation system 104 can further provide the aforementioned or other financial information associated with the third-party system 908 for display via the client device 906. In some cases, the inter-network facilitation system 104 links more than one third-party system 908, receiving account information for accounts associated with each respective third-party system 908 and performing operations or transactions between the different systems via authorized network connections.

In particular embodiments, the inter-network facilitation system 104 may interface between an online banking system and a credit processing system via the network 904. For example, the inter-network facilitation system 104 can provide access to a bank account of a third-party system 908 and linked to a user account within the inter-network facilitation system 104. Indeed, the inter-network facilitation system 104 can facilitate access to, and transactions to and from, the bank account of the third-party system 908 via a client application of the inter-network facilitation system 104 on the client device 906. The inter-network facilitation system 104 can also communicate with a credit processing system, an ATM system, and/or other financial systems (e.g., via the network 904) to authorize and process credit charges to a credit account, perform ATM transactions, perform transfers (or other transactions) across accounts of different third-party systems 908, and to present corresponding information via the client device 906.

In particular embodiments, the inter-network facilitation system 104 includes a model for approving or denying transactions. For example, the inter-network facilitation system 104 includes a transaction approval machine learning model that is trained based on training data such as user account information (e.g., name, age, location, and/or income), account information (e.g., current balance, average balance, maximum balance, and/or minimum balance), credit usage, and/or other transaction history. Based on one or more of these data (from the inter-network facilitation system 104 and/or one or more third-party systems 908), the inter-network facilitation system 104 can utilize the transaction approval machine learning model to generate a prediction (e.g., a percentage likelihood) of approval or denial of a transaction (e.g., a withdrawal, a transfer, or a purchase) across one or more networked systems.

The inter-network facilitation system 104 may be accessed by the other components of network environment 900 either directly or via network 904. In particular embodiments, the inter-network facilitation system 104 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, the inter-network facilitation system 104 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 906, or an inter-network facilitation system 104 to manage, retrieve, modify, add, or delete, the information stored in data store.

In particular embodiments, the inter-network facilitation system 104 may provide users with the ability to take actions on various types of items or objects, supported by the inter-network facilitation system 104. As an example, and not by way of limitation, the items and objects may include financial institution networks for banking, credit processing, or other transactions, to which users of the inter-network facilitation system 104 may belong, computer-based applications that a user may use, transactions, interactions that a user may perform, or other suitable items or objects. A user may interact with anything that is capable of being represented in the inter-network facilitation system 104 or by an external system of a third-party system, which is separate from inter-network facilitation system 104 and coupled to the inter-network facilitation system 104 via a network 904.

In particular embodiments, the inter-network facilitation system 104 may be capable of linking a variety of entities. As an example, and not by way of limitation, the inter-network facilitation system 104 may enable users to interact with each other or other entities, or to allow users to interact with these entities through an application programming interfaces (“API”) or other communication channels.

In particular embodiments, the inter-network facilitation system 104 may include a variety of servers, sub-systems, programs, modules, logs, and data stores. In particular embodiments, the inter-network facilitation system 104 may include one or more of the following: a web server, action logger, API-request server, transaction engine, cross-institution network interface manager, notification controller, action log, third-party-content-object-exposure log, inference module, authorization/privacy server, search module, user-interface module, user-profile (e.g., provider profile or requester profile) store, connection store, third-party content store, or location store. The inter-network facilitation system 104 may also include suitable components such as network interfaces, security mechanisms, load balancers, failover servers, management-and-network-operations consoles, other suitable components, or any suitable combination thereof. In particular embodiments, the inter-network facilitation system 104 may include one or more user-profile stores for storing user profiles for transportation providers and/or transportation requesters. A user profile may include, for example, biographic information, demographic information, financial information, behavioral information, social information, or other types of descriptive information, such as interests, affinities, or location.

The web server may include a mail server or other messaging functionality for receiving and routing messages between the inter-network facilitation system 104 and one or more client devices 906. An action logger may be used to receive communications from a web server about a user's actions on or off the inter-network facilitation system 104. In conjunction with the action log, a third-party-content-object log may be maintained of user exposures to third-party-content objects. A notification controller may provide information regarding content objects to a client device 906. Information may be pushed to a client device 906 as notifications, or information may be pulled from client device 906 responsive to a request received from client device 906. Authorization servers may be used to enforce one or more privacy settings of the users of the inter-network facilitation system 104. A privacy setting of a user determines how particular information associated with a user can be shared. The authorization server may allow users to opt in to or opt out of having their actions logged by the inter-network facilitation system 104 or shared with other systems, such as, for example, by setting appropriate privacy settings. Third-party-content-object stores may be used to store content objects received from third parties. Location stores may be used for storing location information received from client devices 906 associated with users.

In addition, the third-party system 908 can include one or more computing devices, servers, or sub-networks associated with internet banks, central banks, commercial banks, retail banks, credit processors, credit issuers, ATM systems, credit unions, loan associates, brokerage firms, linked to the inter-network facilitation system 104 via the network 904. A third-party system 908 can communicate with the inter-network facilitation system 104 to provide financial information pertaining to balances, transactions, and other information, whereupon the inter-network facilitation system 104 can provide corresponding information for display via the client device 906. In particular embodiments, a third-party system 908 communicates with the inter-network facilitation system 104 to update account balances, transaction histories, credit usage, and other internal information of the inter-network facilitation system 104 and/or the third-party system 908 based on user interaction with the inter-network facilitation system 104 (e.g., via the client device 906). Indeed, the inter-network facilitation system 104 can synchronize information across one or more third-party systems 908 to reflect accurate account information (e.g., balances, transactions, etc.) across one or more networked systems, including instances where a transaction (e.g., a transfer) from one third-party system 908 affects another third-party system 908.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

1. A computer-implemented method comprising:
receiving, from a first transaction computer network, a first transaction associated with a first event corresponding to a first network schema, wherein the first event comprises a first set of transaction information for the first transaction;
converting, utilizing a unified transaction model, the first transaction and the first event corresponding to the first network schema to a first unified transaction schema container under a unified transaction schema;
publishing a unified transaction stream comprising the first transaction and the first event in the first unified transaction schema container to a plurality of computer service systems;
receiving, from the first transaction computer network, a second event for the first transaction corresponding to the first network schema, wherein the second event comprises a second set of transaction information for the first transaction that is different from the first set of transaction information;
generating a modified first unified transaction schema container from the first unified transaction schema container by converting, utilizing the unified transaction model, the second event for the first transaction corresponding to the first network schema under the unified transaction schema and including the converted second event in the first unified transaction schema container;
publishing the unified transaction stream comprising the first transaction, the first event, and the second event in the modified first unified transaction schema container to the plurality of computer service systems;
receiving, from a second transaction computer network, a second transaction associated with a plurality of events corresponding to a second network schema;
converting, utilizing the unified transaction model, the second transaction comprising the plurality of events corresponding to the second network schema to a second unified transaction schema container under the unified transaction schema;
publishing the unified transaction stream comprising the second transaction and the plurality of events in the second unified transaction schema container to the plurality of computer service systems; and
generating, utilizing a machine learning model, an account prediction from the first unified transaction schema container or the second unified transaction schema container via the unified transaction stream.

2. The computer-implemented method of claim 1, wherein the unified transaction model utilizes machine learning to convert the first transaction and the first event corresponding to the first network schema by:
extracting information from the first set of transaction information for the first transaction; and
classifying the extracted information to map the extracted information to fields of the first unified transaction schema container under the unified transaction schema.

3. The computer-implemented method of claim 1, wherein the first unified transaction schema container comprises, for the first event, an event identifier, an event type, an event time, and an event description.

4. The computer-implemented method of claim 1, wherein the account prediction comprises a fraud prediction, a risk prediction, a base limit value prediction, or a transaction approval prediction.

5. The computer-implemented method of claim 4, further comprising, in response to receiving the second event, generating the modified first unified transaction schema container to comprise an updated transaction version identifier, a modified transaction state, and a second event identifier to include the second event.

6. The computer-implemented method of claim 1, wherein publishing the unified transaction stream comprises transmitting the first unified transaction schema container or the modified first unified transaction schema container to at least one of a: computer-implemented security analysis system, a digital data warehousing system, a transaction system, or a digital asset modification system.

7. The computer-implemented method of claim 1, wherein:
receiving, from the first transaction computer network, the first transaction corresponding to the first network schema comprises receiving a card transaction, via a card transaction computer network corresponding to a card network schema;
receiving the first event comprises receiving an authorization event or a settlement event for the first transaction corresponding to the card network schema; and
converting the first transaction to the first unified transaction schema container comprises including the authorization event or the settlement event through a first event identifier indicating the authorization event or the settlement event as part of the first unified transaction schema container.

8. The computer-implemented method of claim 1, wherein receiving, from the second transaction computer network, the second transaction associated with the plurality of events corresponding to the second network schema comprises receiving an ACH transaction, via an ACH transaction computer network, associated with an authorization event and a settlement event corresponding to an ACH network schema; and
converting the second transaction to the second unified transaction schema container comprises including the authorization event and the settlement event through an event identifier indicating the authorization event and an additional event identifier indicating the settlement event as part of the second unified transaction schema container.

9. The computer-implemented method of claim 1, wherein:
receiving the plurality of events for the second transaction comprises receiving a first settlement event and a second settlement event for the second transaction, and
converting the second transaction to the second unified transaction schema container comprises including the first settlement event and the second settlement event through a first settlement identifier indicating the first settlement event and a second settlement identifier indicating the second settlement event as part of the second unified transaction schema container.

10. A non-transitory computer-readable medium comprising instructions that, when executed by at least one processor, cause a computing device to:
receiving, from a first transaction computer network, a first transaction associated with a first event corresponding to a first network schema, wherein the first event comprises a first set of transaction information for the first transaction;
convert, utilizing a unified transaction model, the first transaction and the first event corresponding to the first network schema to a first unified transaction schema container under a unified transaction schema;
publish a unified transaction stream comprising the first transaction and the first event in the first unified transaction schema container to a plurality of computer service systems;
receive, from the first transaction computer network, a second event for the first transaction corresponding to the first network schema, wherein the second event comprises a second set of transaction information for the first transaction that is different from the first set of transaction information;
generate a modified first unified transaction schema container from the first unified transaction schema container by converting, utilizing the unified transaction model, the second event for the first transaction corresponding to the first network schema under the unified transaction schema and including the converted second event in the first unified transaction schema container;
publish the unified transaction stream comprising the first transaction, the first event, and the second event in the modified first unified transaction schema container to the plurality of computer service systems;
receive, from a second transaction computer network, a second transaction associated with a plurality of events corresponding to a second network schema;
convert, utilizing the unified transaction model, the second transaction comprising the plurality of events corresponding to the second network schema to a second unified transaction schema container under the unified transaction schema;
publish the unified transaction stream comprising the second transaction and the plurality of events in the second unified transaction schema container to the plurality of computer service systems; and
generating, utilizing a machine learning model, an account prediction from the first unified transaction schema container or the second unified transaction schema container via the unified transaction stream.

11. The non-transitory computer-readable medium of claim 10, wherein the unified transaction model utilizes machine learning to convert the first transaction and the first event corresponding to the first network schema by:
extracting information from the first set of transaction information for the first transaction; and
classifying the extracted information to map the extracted information to fields of the first unified transaction schema container under the unified transaction schema.

12. The non-transitory computer-readable medium of claim 10, wherein the first unified transaction schema container comprises a unified transaction identifier, a transaction version identifier, a transaction state, and a first event identifier reflecting the first event.

13. The non-transitory computer-readable medium of claim 12, further comprising instructions that, when executed by the at least one processor, cause the computing device to, in response to receiving the second event, generate the modified first unified transaction schema container to comprise an updated transaction version identifier, a modified transaction state, and a second event identifier to include the second event.

14. The non-transitory computer-readable medium of claim 10, further comprising instructions that, when executed by the at least one processor, cause the computing device to publish the unified transaction stream by transmitting the first unified transaction schema container or the modified first unified transaction schema container to at least one of a: computer-implemented security analysis system, a digital data warehousing system, a transaction system, or a digital asset modification system.

15. The non-transitory computer-readable medium of claim 10, further comprising instructions that, when executed by the at least one processor, cause the computing device to:
receive, from the first transaction computer network, the first transaction corresponding to the first network schema by receiving a card transaction, via a card transaction computer network corresponding to a card network schema;
receive an authorization event or a settlement event for the first transaction corresponding to the card network schema as the first event; and
convert the first transaction to the first unified transaction schema container by including the authorization event or the settlement event through a first event identifier indicating the authorization event or the settlement event as part of the first unified transaction schema container.

16. A system comprising:
at least one processor; and
at least one non-transitory computer-readable storage medium storing instructions that, when executed by the at least one processor, cause the system to:
receive, from a first transaction computer network, a first transaction associated with a first event corresponding to a first network schema, wherein the first event comprises a first set of transaction information for the first transaction;
convert, utilizing a unified transaction model, the first transaction and the first event corresponding to the first network schema to a first unified transaction schema container under a unified transaction schema;
publish a unified transaction stream comprising the first transaction and the first event in the first unified transaction schema container to a plurality of computer service systems;
receive, from the first transaction computer network, a second event for the first transaction corresponding to the first network schema, wherein the second event comprises a second set of transaction information for the first transaction that is different from the first set of transaction information;
generate a modified first unified transaction schema container from the first unified transaction schema container by converting, utilizing the unified transaction model, the second event for the first transaction corresponding to the first network schema under the unified transaction schema and including the converted second event in the first unified transaction schema container;
publish the unified transaction stream comprising the first transaction, the first event, and the second event in the modified first unified transaction schema container to the plurality of computer service systems;
receive, from a second transaction computer network, a second transaction associated with a plurality of events corresponding to a second network schema;
convert, utilizing the unified transaction model, the second transaction comprising the plurality of events corresponding to the second network schema to a second unified transaction schema container under the unified transaction schema;
publish the unified transaction stream comprising the second transaction and the plurality of events in the second unified transaction schema container to the plurality of computer service systems; and
generating, utilizing a machine learning model, an account prediction from the first unified transaction schema container or the second unified transaction schema container via the unified transaction stream.

17. The system of claim 16, wherein the first unified transaction schema container comprises, for the first event, an event identifier, an event type, an event time, and an event description.

18. The system of claim 16, further comprising instructions that, when executed by the at least one processor, cause the system to:
receive, from the first transaction computer network, the first transaction corresponding to the first network schema by receiving a card transaction, via a card transaction computer network corresponding to a card network schema;
receive an authorization event or a settlement event for the first transaction corresponding to the card network schema as the first event; and
convert the first transaction to the first unified transaction schema container by including the authorization event or the settlement event through a first event identifier indicating the authorization event or the settlement event as part of the first unified transaction schema container.

19. The system of claim 16, wherein the first unified transaction schema container comprises a unified transaction identifier, a transaction version identifier, a transaction state, and a first event identifier reflecting the first event.

20. The system of claim 19, further comprising instructions that, when executed by the at least one processor, cause the system to, in response to receiving the second event, generate the modified first unified transaction schema container to comprise an updated transaction version identifier, a modified transaction state, and a second event identifier to include the second event.
